(19) United States
(12) Patent Application Publication
(10) Pub. No.: US 2011/0267185 A1
(43) Pub. Date: Nov. 3, 2011

(54) VEHICLE AND DRIVER MONITORING SYSTEM AND METHOD THEREOF

(75) Inventors: Li Zhang, Clifton Park, NY (US); Patricia Denise Mackenzie, Clifton Park, NY (US); Joseph James Salvo, Schenectady, NY (US); John William Carbone, Ballston Spa, NY (US); Charles Burton Theurer, Alplaus, NY (US)

(73) Assignee: GENERAL ELECTRIC COMPANY, SCHENECTADY, NY (US)

(21) Appl. No.: 12/770,872

(22) Filed: Apr. 30, 2010

(51) Int. Cl. B60Q 1/00

(52) U.S. Cl. 340/437; 340/438; 340/439

(57) ABSTRACT

A monitoring system is presented. The monitoring system includes a plurality of sensing devices disposed at various locations of a vehicle to generate signals comprising vibration and acoustic data of the vehicle, a processing device configured to determine one or more events based upon the generated signals, and generate alert messages based upon the one or more events.

### BACKGROUND

Embodiments of the invention relate generally to a monitoring system and method thereof and, more specifically to a vehicle and driver monitoring system and method thereof.

Fleet management generally includes management functions related to commercial vehicles. The management functions, for example, may include financing of vehicles, maintenance of vehicles, telematics of vehicles, management of fuel, monitoring of vehicles, and health and safety of vehicles. Typically, companies that rely on transportation require fleet management to minimize risks associated with vehicles, improve efficiency and reduce costs of overall transportation. Such companies are highly interested in monitoring the vehicles and the associated drivers.

Conventionally vehicles and associated drivers are monitored via systems that are located at remote locations. Typically, one or more devices in the vehicles transmit data to the systems at different intervals of time. The systems receive the data and monitor the vehicles based upon the received data. However, the transmission of the data at the different intervals of time increases the required communication bandwidth. Consequently, the increase in the required communication bandwidth increases communication costs. Furthermore, with this current approach, it is challenging to monitor the vehicles and associated drivers in realtime.

Accordingly, it is highly desirable to develop an on-board vehicle and driver monitoring system that monitors vehicles and associated drivers in realtime. Furthermore, there is a need of a vehicle and driver monitoring system that determines the driving behavior of drivers and the driving skills of drivers in realtime. Furthermore, there is a need of a vehicle and driver monitoring system that reduces the required communication cost.

### BRIEF DESCRIPTION

Briefly in accordance with one aspect of the technique, a monitoring system is presented. The monitoring system includes a plurality of sensing devices disposed at various locations of a vehicle to generate signals comprising vibration and acoustic data of the vehicle, a processing device configured to determine one or more events based upon the generated signals, and generate alert messages based upon the one or more events.

In accordance with a further aspect of the technique, a monitoring system is presented. The monitoring system includes a plurality of sensing devices disposed at various locations of a vehicle to generate signals comprising transient signals, wherein the transient signals comprise vibration and acoustic data of the vehicle, a processing device configured to extract the transient signals from the generated signals, compare the transient signals to one or more predetermined threshold values, determine one or more events based upon the comparison of the transient signals to the one or more predetermined threshold values, and generate alert messages based upon the one or more events.

In accordance with still another aspect of the technique, a method for monitoring a vehicle and an associated driver is presented. The method includes steps of generating signals comprising vibration and acoustic data of the vehicle, determining one or more events based upon the generated signals, and generating alert messages based upon the one or more events.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic illustration of a vehicle and driver monitoring system, in accordance with an embodiment of the invention;

FIG. 2 is a block diagram of an exemplary subsystem and an exemplary backend office in the vehicle and driver monitoring system of FIG. 1;

FIG. 3 is a flowchart representing steps in a method for monitoring a vehicle and an associated driver, in accordance with an embodiment of the present invention;

FIG. 4 is a flow chart representing steps in a method for generation of one or more events that are utilized for monitoring a vehicle and an associated driver of FIG. 3, in accordance with an embodiment of the present invention; and

FIG. 5 is a flow chart representing steps in an alternative method for generation of one or more events that are utilized for monitoring a vehicle and an associated driver of FIG. 3, in accordance another embodiment of the present invention.

### DETAILED DESCRIPTION

As discussed in detail below, embodiments of the invention include a vehicle and driver monitoring system for monitoring one or more conditions of a vehicle and determining the driving behavior of an associated driver in realtime. The vehicle, for example, may include buses, trucks, ships, cars, and the like. In certain embodiments, the vehicle and driver monitoring system may include a plurality of sensing devices that are disposed within the vehicle. The sensing devices generate signals by sensing vibration and acoustic data of the vehicle. The vibration and acoustic data may include acceleration, displacement, vibration velocity, vibration acceleration, acoustic emission of the vehicle, or the like. It may be noted that the acceleration, displacement, vibration velocity, vibration acceleration, acoustic emission of the vehicle, or the like are generated in the vehicle due to an occurrence of one or more events associated with the vehicle. As used herein, the term “event” may be used to refer to an instance associated with a vehicle that may be used to determine one or more conditions of a vehicle. By way of a non-limiting example, the events may include a sudden stoppage, a constant lane change, drifting, hard braking, hard acceleration, low idle detection, curb hitting, pothole hitting, banging, a collision, a roll over, a vehicle misalignment, a brake wear, a wheel bearing wear, a tire wear, low tire pressure, and the like.

Furthermore, the generated signals are received by a subsystem that is operationally coupled to the sensing devices. The subsystem determines the events associated with the vehicle based upon the generated signals. In one embodiment, the subsystem is disposed within the vehicle for an on-board determination of the events. In addition, the subsystem generates alert messages based upon the events. As used herein, the term “alert message” may be used to refer to a message or other method of garnering attention or capturing events, such as, an alarm, or the like. The alert messages may include an event, a warning message, a prevention step, a date of an event, a time of an event, the driving behavior of a driver, or combinations thereof. In one embodiment, the alert messages are generated on-board while the vehicle is driven by a driver. In a particular embodiment, the alert messages are displayed on an on-board display device.

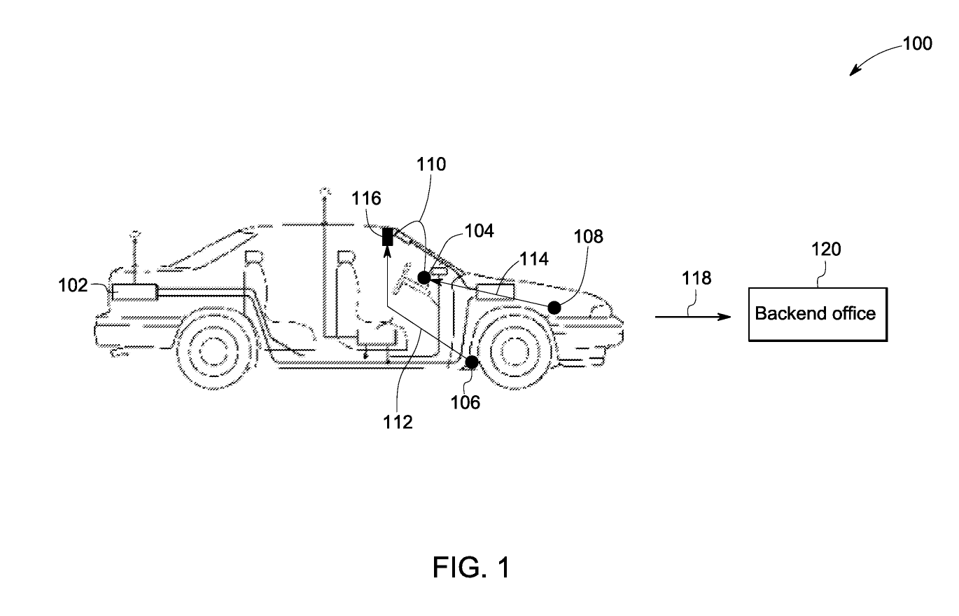

Referring now to FIG. 1, a diagrammatic illustration of a vehicle and driver monitoring system 100, in accordance with embodiments of the invention, is depicted. In operation, the vehicle and driver monitoring system 100 monitors a vehicle 102 to determine one or more conditions of the vehicle 102. The system 100 also determines and evaluates the driving skills or the driving behavior of a driver associated with the vehicle 102. The system 100 includes a plurality of sensing devices 104, 106, 108 that are disposed at various locations of the vehicle 102. By way of a non-limiting example, the sensing devices 104, 106, 108 may include an accelerometer, an acoustic sensor, or the like.

In the presently contemplated configuration, the sensing device 104 generates signals 110, the sensing device 106 generates signals 112 and the sensing device 108 generates signals 114. The sensing devices 104, 106, 108 generate the signals 110, 112, 114 by sensing vibration and acoustic data of the vehicle 102. As previously noted, the vibration and acoustic data may include acceleration of the vehicle 102, displacement of the vehicle 102, vibration velocity of the vehicle 102, vibration acceleration of the vehicle 102, acoustic emission of the vehicle 102, or the like.

As shown in FIG. 1, while the sensing device 104 is disposed within the dashboard of the vehicle 102, the sensing device 106 is disposed near a wheel of the vehicle 102. In addition, the sensing device 108 is disposed under the hood of the vehicle 102. In certain embodiments, the sensing devices, 104, 106, 108 may be disposed within or on the dashboard, near or on the wheels of a vehicle, under the hood of a vehicle, and the like. It may be noted that while in the presently contemplated configuration, the vehicle 102 includes the three sensing devices 104, 106, 108, a number of sensing devices may be included based upon the type of vehicles, the number of axles, the accuracy expectations, and the like.

Moreover, the vehicle 102 may include a vehicle and driver monitoring subsystem 116 installed within or on the vehicle 102. It should be noted that the location of the subsystem 116 may depend upon a category, a type, a shape and a size of a vehicle. In certain embodiments, the subsystem 116 receives the generated signals 110, 112, 114 from the sensing devices 104, 106, 108, respectively. Furthermore, the subsystem 116 determines one or more events based upon the generated signals 110, 112, 114. As previously noted, the term “event” may be used to refer to an instance associated with a vehicle that may be used to determine one or more conditions of a vehicle. By way of a non-limiting example, the events may include a sudden stoppage, a constant lane change, drifting, hard braking, hard acceleration, low idle detection, curb hitting, pothole hitting, banging, a collision, a roll over, a vehicle misalignment, a brake wear, a wheel bearing wear, a tire wear, low tire pressure, and the like.

In addition, the subsystem 116 determines and evaluates the driving skills or the driving behavior of a driver associated with the vehicle 102. The subsystem 116, for example, may determine the driving skills or the driving behavior of the driver based upon the events. The subsystem 116 also generates alert messages 118 based upon the events. As previously noted, the alert messages 118 are generated on-board while the vehicle 102 is driven by a driver. The alert messages 118, for example, may include an event, a warning message, a prevention step, a date of an event, a time of an event, the driving behavior of a driver, name of a driver, reason of an event, or combinations thereof. By way of a non-limiting example, if a vehicle is over-speeding, then the subsystem 116 may generate the following alert message: “Name of Driver: James Bratt, Event: over-speeding; Date: Jan. 10, 2009, Time: 2 P.M.” In certain embodiments, the subsystem 116 accumulates alert messages, such as, the alert messages 118 generated over a predetermined time period. Furthermore, the subsystem 116 may be used to determine the driving behavior of a driver, determine the driving skills of a driver, generate driving behavior reports of drivers, general predicted life of a vehicle component, and schedule proactive vehicle maintenance appointments based upon the accumulated alert messages.

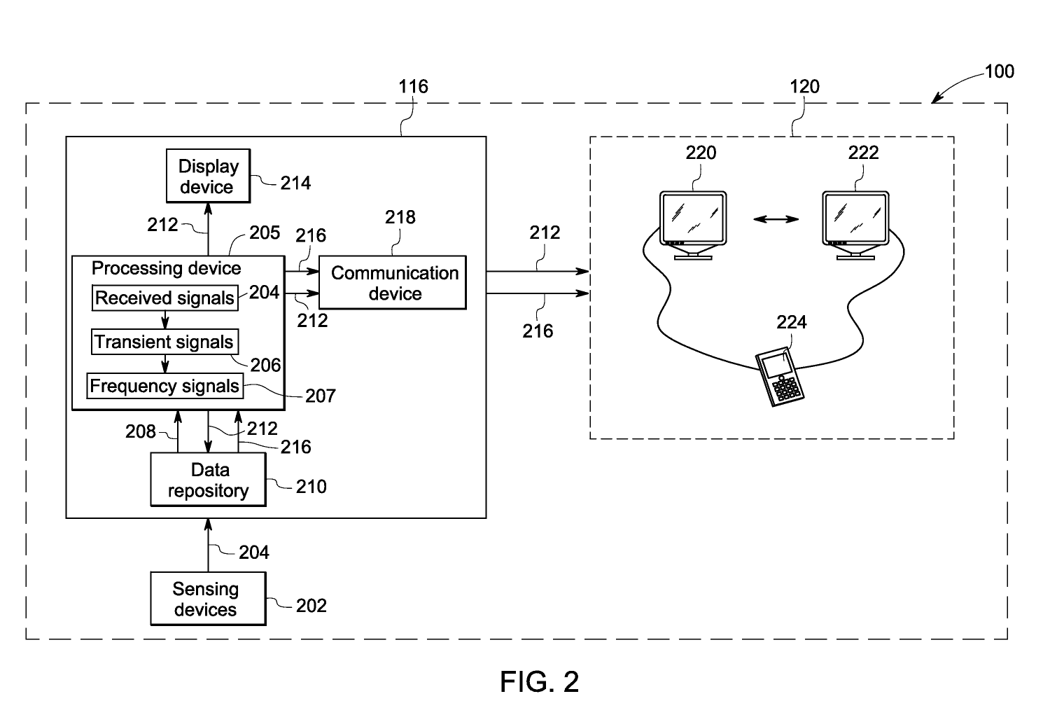

As shown in FIG. 1, in one embodiment the system 100 includes a backend office 120 to receive the alert messages 118 from the vehicle 102. In one embodiment, the backend office 120 may accumulate alert messages received over a predetermined time period. In certain embodiments, the backend office 120 may generate driving behavior reports of drivers, predict life of a vehicle component, and schedule proactive vehicle maintenance appointments based upon the accumulated alert messages. The generation of the alert messages, determination of the driving skills, generation of the driving behavior reports, prediction of life of a component in a vehicle, and scheduling of proactive vehicle maintenance that will be explained in greater detail with reference to FIGS. 2-4. In other contemplated embodiments, the vibration and acoustic data is analyzed by an on-board processor, and the on-board processor generates driving behavior reports of drivers, predicts life of a vehicle component, and schedules proactive vehicle maintenance appointments based upon the accumulated alert messages.

FIG. 2 is a block diagram of the subsystem 116 and the backend office 120 in the system 100 of FIG. 1. As shown in the presently contemplated configuration, the system 100 includes sensing devices 202 to generate signals 204. The sensing devices 202 generate signals 204 by sensing vibration and acoustic data of the vehicle 102 (see FIG. 1). The vibration and acoustic data may include acceleration of the vehicle 102, displacement of the vehicle 102, vibration velocity of the vehicle 102, vibration acceleration of the vehicle 102, acoustic emission of the vehicle 102, or combinations thereof. It may be noted that the generated signals 204 may include noise signals and transient signals 206. As used herein, the term “noise signals” may be used to refer to signals generated by normal vehicle operation and/or an unwanted disturbance in the signals 204 that may distort or bury information carried by the generated signals 204. Further, the term “transient signals” may be representative of the fault-related vibration and acoustic data that is generated due to faulted condition of the vehicle 102.

Furthermore, the generated signals 204 are received by the subsystem 116. In embodiment of FIG. 2, the subsystem 116 includes a processing device 205 that extracts the transient signals 206 from the generated signals 204. In one embodiment, the processing device 205 extracts the transient signals 206 by transforming the generated signals 204 using techniques including kurtosis, enveloping, Fourier transform, short-time Fourier transform, autoregressive modeling, synchronous averaging, matching filtering, order tracking, continuous wavelet transformation, discrete wavelet transformation, correlation, entropy, fuzzy logic, neural networks, and the like. It may be noted that while the processing device 205 extracts the transient signals 206, the transient signals 206 may still have one or more of the noise signals.

Moreover, in an exemplary embodiment, the processing device 205 converts the transient signals 206 to frequency signals 207. The frequency signals 207 are frequency domain representations of the transient signals 206. The transient signals 206, for example, may be converted to the frequency signals 207 by using methods, such as, a Fourier transformation, a short-time Fourier transformation, a wavelet envelope thresholding technique, a power spectral density technique, spectrum kurtosis, and the like.

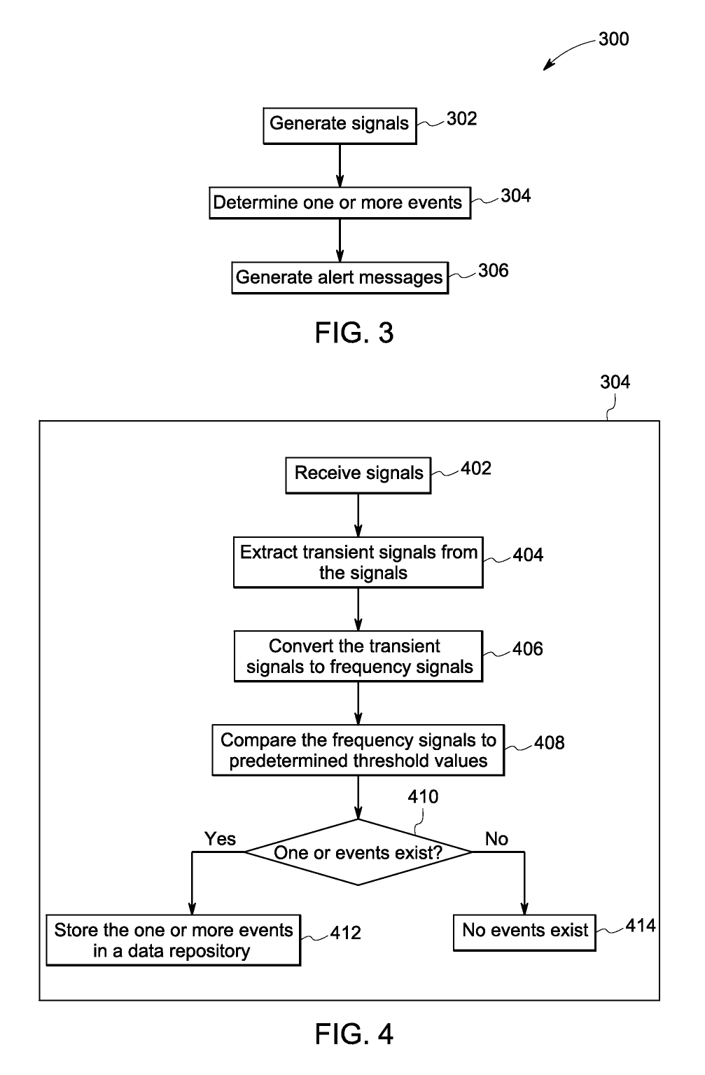

Furthermore, the processing device 205 extracts predetermined threshold values 208 from a data repository 210. As used herein, the term “predetermined threshold value” may be used to refer to a value that may be used to determine one or more events. In addition, the processing device 205 determines one or more events based upon a comparison of the transient signals 206 to the predetermined threshold values 208 and/or a comparison of the frequency signals 207 to the predetermined threshold values 208. The determination of one or more events consequent to the comparison of the transient signals 206 to the predetermined threshold values and/or the comparison of the frequency signals 207 to the predetermined threshold values will be explained in greater detail with reference to FIGS. 3-5.

In certain embodiments, the processing device 205 generates alert messages 212 based upon the events. The alert messages 212, for example, may include name of a driver, a type of an event, a day of an event, a time of an event, the driving behavior of a driver, the driving skills of a driver, and the like. For example, the processing device 205 may generate an alert message representing the driving behavior of a driver, based upon events including “hitting a pothole,” “continuous lane change” and “fast acceleration.” As shown in FIG. 2, the alert messages 212 are further transmitted to a display device 214 by the processing device 205. In one embodiment, the alert messages 212 may be displayed on the display device 214. In another embodiment, the alert messages 212 may be read on an audio device (not shown).

Furthermore, the processing device 205 transmits the alert messages 212 to the data repository 210. The data repository 210 accumulates multiple alert messages 216 received over a predetermined time period from the processing device 205. In one embodiment, the accumulated alert messages 216 includes the alert messages 212, as described above. The processing device 205 receives the accumulated alert messages 216 from the data repository 210 and processes the accumulated alert messages 216 to determine the driving behavior of a driver. For example, if a number of the accumulated alert messages 216 is greater than a predetermined number, then the processing device 205 determines the driving behavior of the driver as ‘unsafe.’ Similarly, if a number of the accumulated alert messages 216 is less than a predetermined number, then the processing device 205 determines the driving behavior of a driver as ‘safe.’ The driving behavior, for example, may include a safe driving behavior, an unsafe driving behavior, or the like.

Moreover, a communication device 218 receives the alert messages 212 and/or the accumulated alert messages 216 from the processing device 205. The communication device 218 transmits the alert messages 212 and/or the accumulated alert messages 216 to the backend office 120. The backend office 120 may generate the driving behavior reports of a driver, predict life of a component of a vehicle, and schedule proactive vehicle maintenance appointments based upon the alert messages 212 and/or the accumulated alert messages 216.

The backend office 120 includes one or more computing devices 220, 222 and may include a mobile device 224. In certain embodiments, the alert messages 212 and/or the accumulated alert messages 216 may be transmitted to the mobile device 224. The mobile device 224, for example, may be a mobile phone of a supervisor, a manager, and the like. Thus, the receipt of the alert messages 212 and/or the accumulated alert messages 216 on the mobile device 224 may update managers, supervisors and vehicle owners about the condition of a vehicle and the driving behavior of associated drivers in realtime. Furthermore, the alert messages 212 may update managers and supervisors in real time of an emergency condition, for example, an accident of a vehicle. In addition, the on-board generation of the alert messages 212 reduces communication cost.

Furthermore, in one embodiment, the accumulated alert messages 216 may be processed by the computing devices 220, 222 to generate driver behavior reports, prediction of life of a vehicle component, and scheduling of proactive vehicle maintenance. For example, if the accumulated alert messages 216 associated with a vehicle indicates multiple collisions of the vehicle, then the computing devices 220, 222 may schedule an appointment for maintenance of the vehicle. Accordingly, multiple collisions of the vehicle may be an indicator of an unsafe driving of a driver. Moreover, in certain embodiments, the computing devices 220, 222, the supervisor, the manager and owners of the vehicle 102 may determine one or more steps based upon the accumulated alert messages 216 and the driver behavior reports. The steps, for example, may include a termination of a driver, a deduction of salary, a repair of a vehicle, reach an accident location, and the like.

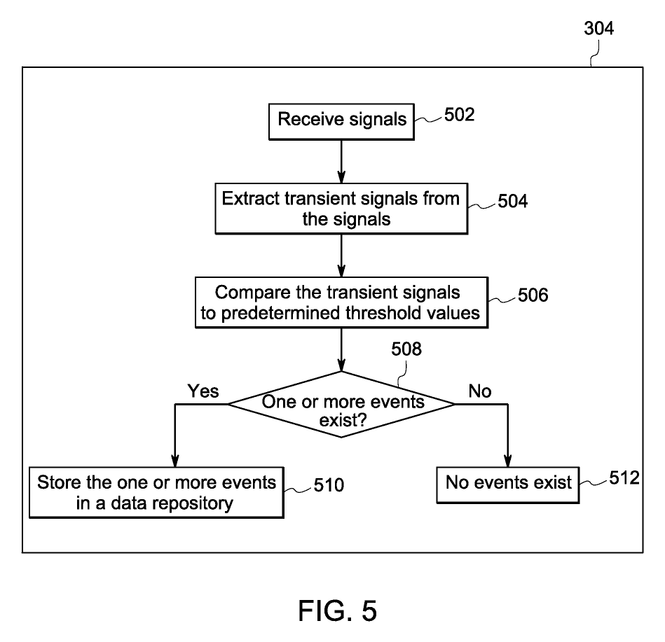

FIG. 3 is a flowchart 300 representing steps in a method for monitoring a vehicle and an associated driver. The method starts at step 302 where signals may be generated by sensing devices that are disposed within the vehicle. The sensing devices sense vibration and acoustic data of the vehicle to generate the signals. The sensing devices, for example, may be the sensing devices 104, 106, 108, 202 (see FIG. 1 and FIG. 2). Further, the generated signals may be the generated signals 110, 112, 114, 204 (see FIG. 1 and FIG. 2). Furthermore, at step 304 one or more events may be determined based upon the generated signals, and at step 306 alert messages are generated. The determination of the one or more events will be described in greater detail with reference to FIG. 4 and FIG. 5.

FIG. 4 is a flow chart illustrating an exemplary method for determining one or more events based upon the signals generated in FIG. 3, in accordance with one embodiment of the invention. More particularly, FIG. 4 describes step 304 of FIG. 3. The method 304 starts at step 402 where the generated signals may be received by a subsystem, such as, the subsystem 116 (see FIG. 1). As previously noted with reference to FIG. 2, the generated signals may include noise signals and transient signals. As used herein, the term “noise signals” may be used to refer to signals that are generated due to a normal operation of the vehicle and/or an unwanted disturbance in the signals that may distort or bury fault-related information carried by generated signals. Further, the term “transient signals” may be representative of the fault-related vibration and acoustic data that is generated due to faulted condition of the vehicle 102.

Subsequently at step 404, the transient signals may be extracted from the generated signals. The transient signals may be extracted by the processing device 205 (see FIG. 2). As previously noted with reference to FIG. 2, the transient signals, for example, may be extracted by implementing techniques including kurtosis, enveloping, Fourier transform, short-time Fourier transform, autoregressive modeling, synchronous averaging, matching filtering, order tracking, continuous wavelet transformation, discrete wavelet transformation, correlation, entropy, fuzzy logic, neural networks, and the like.

In certain embodiments, the transient signals are converted to frequency signals at step 406. The transient signals may be converted to the frequency signals via techniques including a Fourier transformation, a short-time Fourier transformation, a wavelet envelope thresholding technique, a power spectral density technique, spectrum kurtosis, and the like.

Subsequently, at step 408, the frequency signals are compared to predetermined threshold values. More particularly, the amplitude of the frequency signals is compared to the predetermined threshold values. As previously noted, the term “predetermined threshold value” may be used to refer to a value that may be used to determine one or more events. In one embodiment, a predetermined threshold value A may be used to determine a sudden stoppage event, whereas another predetermined threshold value B may be used to determine a lane change event. Moreover, at step 410, a check is carried out to verify an existence of one or more events. The existence of one or more events is verified based upon the comparison of the predetermined threshold values to the amplitude of the frequency signals. For example, a frequency signal f is compared to a predetermined threshold value A that may be used to determine a sudden stoppage event. In such an example, if the amplitude of the frequency signal f is less than the predetermined threshold value A, then determination of a sudden stoppage event may be reported.

Furthermore, if the events are determined at step 410, then the control is transferred at step 412. As depicted by step 412, the events are stored in a data repository, such as, the data repository 210 (see FIG. 2). Referring again to step 410, if it is verified that the events do not exist, then the control is transferred to step 414. At step 414, existence of no events associated with the vehicle is reported.

It may be noted that all the events associated with a vehicle may not be determined based upon the comparison of the frequency signals to the predetermined threshold values. However, events that are not determined based upon the comparison of the frequency signals with the predetermined threshold values may be determined based upon a comparison of the transient signals with the predetermined threshold values. Therefore, in certain embodiments, the transient signals may be compared to the predetermined threshold values. FIG. 5 is a flow chart illustrating an alternative method for determining one or more events based upon a comparison of the predetermined threshold values with the transient signals. More particularly, FIG. 5 describes an exemplary method 304 for processing step 304 of FIG. 3.

The method 304 starts at step 502 where the generated signals may be received by the subsystem 116 (See FIG. 2). Subsequently at step 504, the transient signals are extracted from the generated signals. In one embodiment, the transient signals are extracted by the processing device 205 (see FIG. 2).

Subsequently, as depicted by step 506, the transient signals are compared to the predetermined threshold values. In one embodiment, when the transient signals are representative of a rigid body acceleration of a vehicle, the acceleration values of the vehicle are compared to the predetermined threshold values. By way of a non-limiting example, a sudden stoppage event may be determined by comparing the acceleration values to a predetermined threshold value S that may be used to determine a sudden stoppage event. Furthermore, at step 508, a check is carried to verify existence of one or more events. The existence of one or more events is determined based upon the comparison of the acceleration values of the vehicle to the predetermined threshold values.

In an exemplary embodiment, the one or more events exist when one or more of the acceleration values of the transient signals are greater or less than one or more of the predetermined threshold values. Accordingly, in continuation with the above example that may determine a sudden stoppage event, if one or more of the acceleration values are determined as less than the predetermined threshold value S, then determination of a sudden stoppage event is determined. Furthermore, if at step 508, one or more events are determined then the control is transferred to step 510. As depicted by step 510, the one or more events are stored in a data repository. Referring back to step 508, if it is determined that one or more events do not exist, then the control may be transferred to step 512. As depicted by step 512, existence of no events of a vehicle is reported.

Referring back to FIG. 3, alert messages are generated at step 306. The alert messages are generated based upon the one or more events determined at step 304. As previously noted with reference to FIG. 2, the alert messages, for example, include an event, a warning message, a prevention step, a date of an event, a time of an event, the driving behavior of a driver, the driving skills of a driver, or combinations thereof. The alert messages, for example, may be displayed on a display device, such as, the display device 214 (see FIG. 2) disposed within the vehicle or may be read on an audio device disposed within the vehicle.

In certain embodiments, the alert messages are transmitted to a backend office, such as, the backend office 120 (see FIG. 2). The alert messages, for example, may include the alert messages 212. (see FIG. 2). In addition, the alert messages are accumulated in a data repository over a predetermined time period. The alert messages, for example, are accumulated by a data repository disposed within a vehicle and/or a data repository in the backend office. The accumulated alert messages, such as, the alert messages 216 (see FIG. 2) are used to determine the driving skills of a driver. For example, if accumulated alert messages of a driver indicates multiple events for last one year, then the driving skills of the driver may be declared as poor.

Furthermore, in certain embodiments, reports are generated based upon the alert messages, the accumulated alert messages, or both. The reports, for example, include the driving behavior reports of a driver, prediction of life of components in a vehicle, and schedule of vehicle maintenance appointments. The driving behavior reports, for example, are generated by extracting the driving behavior of a driver from the alert messages, the accumulated alert messages, or both. Furthermore, the prediction of a life of a vehicle component and schedule of vehicle maintenance appointments are determined based upon a number of events and the events extracted from the alert messages and the accumulated alert messages. In one embodiment, the reports may be generated by the backend office. In another embodiment, the reports may be generated by a subsystem, such as the subsystem 116. The reports, for example, may be used by the backend office to take steps including a termination of a driver, warning a driver, awarding a driver, and the like.

The various embodiments of the invention result in realtime monitoring of a vehicle and an associated driver. The invention includes an on-board processing device that determines the vehicle condition and the driving behavior of a driver in realtime. Furthermore, the on-board determination of the vehicle condition and the driving behavior alerts the driver while the driver is driving the car. The present invention does not require transfer of raw data to a backend office and thus, the embodiments disclosed herein reduce the overall communication bandwidth and the communication cost required for transmission of the raw data.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A monitoring system, comprising:
a plurality of sensing devices disposed at various locations of a vehicle to generate signals comprising vibration and acoustic data of the vehicle;
a processing device configured to:
determine one or more events based upon the generated signals; and
generate alert messages based upon the one or more events.

2. The system of claim 1 wherein the one or more events comprise a sudden stoppage event, a constant lane change event, a drifting event, a hard braking event, a hard acceleration event, a low idle detection event, a hitting curb event, a pothole hitting event, a banging event, a collision event, a roll over event, a vehicle misalignment event, a brake wear event, a wheel bearing wear event, a tire wear event, a low tire pressure event, and the like.

3. The system of claim 1, wherein the alert messages comprise an event, a warning message, a prevention step, name of a driver, a date of an event, a time of an event, the driving behavior of a driver, driving skills of a driver, or combinations thereof.

4. The system of claim 1, further comprising a communication device to transmit the alert messages to a backend office.

5. The system of claim 4, wherein the backend office comprises one or more computing devices and one or more mobile devices to receive the alert messages from the communication device.

6. The system of claim 5, wherein the one or more computing devices are configured to generate driving behavior reports of a driver, predict lives of components in a vehicle, schedule vehicle maintenance appointments, or combinations thereof.

7. The system of claim 1, further comprising a data repository for receiving the alert messages from the processing device.

8. The system of claim 7, wherein the data repository accumulates alert messages received over a determined time period resulting in accumulated alert messages.

9. The system of claim 8, wherein the processing device is configured to determine the driving behavior of a driver and the driving skills of the driver over the determined time period based upon the accumulated alert messages.

10. The system of claim 1, wherein the processing device is disposed within the vehicle.

11. A monitoring system, comprising:
a plurality of sensing devices disposed at various locations of a vehicle to generate signals comprising transient signals, wherein the transient signals comprise vibration and acoustic data of the vehicle;
a processing device configured to:
extract the transient signals from the generated signals;
compare the transient signals to one or more predetermined threshold values;
determine one or more events based upon the comparison of the transient signals to the one or more predetermined threshold values; and
generate alert messages based upon the one or more events.

12. The monitoring system of claim 11, wherein the processing device is further configured to:
convert the transient signals to frequency signals;
compare the frequency signals to the one or more predetermined threshold values; and
determine the one or more events based upon the comparison of the frequency signals to the one or more predetermined threshold values.

13. A method for monitoring a vehicle and an associated driver, comprising:
generating signals comprising vibration and acoustic data of the vehicle;
determining one or more events based upon the generated signals; and
generating alert messages based upon the one or more events.

14. The method of claim 13, wherein determining the one or more events comprises:
extracting transient signals from the generated signals;
converting the transient signals to frequency signals; and
comparing the frequency signals to predetermined threshold values to determine the one or more events.

15. The method of claim 13, wherein determining the one or more events comprises:
extracting transient signals from the generated signals; and
comparing the transient signals to predetermined threshold values to determine the one or more events.

16. The method of claim 14, wherein extracting the transient signals from the generated signals comprises determining a wavelet transformation of the generated signals.

17. The method of claim 14, wherein extracting the transient signals from the generated signals comprises implementing one or more techniques on the generated signals, the techniques, comprising kurtosis, enveloping, Fourier transform, short-time Fourier transform, autoregressive modeling, synchronous averaging, matching filtering, order tracking, continuous wavelet transformation, discrete wavelet transformation, correlation, entropy, fuzzy logic, neural networks, and combinations thereof.

18. The method of claim 14, wherein converting the transient signals to frequency signals comprises implementing one or more techniques on the transient signals, the techniques, comprising a Fourier transformation, a short-time Fourier transformation, a wavelet envelope thresholding technique, a power spectral density technique, spectrum kurtosis, or combinations thereof.
